(19) United States
(12) Patent Application Publication
(10) Pub. No.: US 2019/0156181 A1
(43) Pub. Date: May 23, 2019

(54) NEURAL NETWORK DEVICE AND COMPUTING DEVICE

(71) Applicant: Kabushiki Kaisha Toshiba, Minato-ku (JP)

(72) Inventors: Takao MARUKAME, Chuo (JP); Kumiko NOMURA, Shinagawa (JP)

(73) Assignee: Kabushiki Kaisha Toshiba, Minato-ku (JP)

(21) Appl. No.: 15/909,446

(22) Filed: Mar. 1, 2018

(30) Foreign Application Priority Data
Nov. 17, 2017 (JP) 2017-222258

(51) Int. Cl. G06N 3/04; G06N 3/08; G06F 7/544; G06F 17/16

(52) U.S. Cl. CPC G06N 3/0454; G06F 17/16; G06F 7/5443; G06N 3/084

(57) ABSTRACT

According to an embodiment, a neural network device includes a control unit, and a matrix computation unit. The control unit causes a plurality of layers to execute a forward process of propagating a plurality of signal values in a forward direction, and a backward process of propagating a plurality of error values in a backward direction. The matrix computation unit performs computation on a plurality of values propagated in the plurality of layers. The matrix computation unit includes (m×n) multipliers, and an addition circuit. The (m×n) multipliers are provided in one-to-one correspondence with (m×n) coefficients included in a coefficient matrix of m rows and n columns. The addition circuit switches a pattern for adding values output from the respective (m×n) multipliers between the forward process and the backward process.

### CROSS-REFERENCE TO RELATED APPLICATIONS

This application is based upon and claims the benefit of priority from Japanese Patent Application No. 2017-222258, filed on Nov. 17, 2017; the entire contents of which are incorporated herein by reference.

### FIELD

Embodiments described herein relate generally to a neural network device and a computing device.

### BACKGROUND

A neural network propagates a signal value to a plurality of layers in a direction from an input layer to an output layer (forward direction) at the time of ordinary computation. In addition, the neural network propagates an error value to a plurality of layers in a direction from the output layer to the input layer (backward direction) at the time of learning.

Furthermore, in the case of propagating a plurality of signal values (or a plurality of error values) between two adjacent layers, the neural network multiplies each of the plurality of signal values output from a previous layer by a coefficient (weight) and adds the plurality of signal values multiplied by the coefficient. That is, the neural network executes multiplication-accumulation (product-sum operation) when propagating a plurality of signal values (or a plurality of error values) between two layers.

In recent years, a device that implements the neural network with hardware has been proposed. In this device, a process at the time of ordinary computation (forward process) is executed by dedicated hardware. However, this device executes a process at the time of learning (backward process) by a processor separate from the dedicated hardware.

The neural network executes multiplication-accumulation between two layers using the same coefficient at the time of ordinary computation and at the time of learning. However, when multiplication-accumulation is executed by a separate processor and the like at the time of ordinary computation and at the time of learning, an error occurs between a coefficient used at the time of ordinary computation and a coefficient used at the time of learning and there is the possibility that the learning accuracy deteriorates.

### BRIEF DESCRIPTION OF THE DRAWINGS

FIG. 1 is a diagram illustrating a configuration of a neural network device according to an embodiment;

FIG. 2 is a diagram illustrating the contents of a forward process;

FIG. 3 is a diagram illustrating the contents of a backward process;

FIG. 4 is a diagram illustrating a first layer and a second layer included in a plurality of layers;

FIG. 5 is a diagram illustrating links between the first layer and the second layer;

FIG. 6 is a diagram illustrating values input to and output from a matrix computation unit in the forward process;

FIG. 7 is a diagram illustrating values input to and output from the matrix computation unit in the backward process;

FIG. 8 is a diagram illustrating the contents of computation in the matrix computation unit and a layer computation unit in the forward process;

FIG. 9 is a diagram illustrating the contents of computation in the matrix computation unit and the layer computation unit in the backward process;

FIG. 10 is a diagram illustrating a configuration of the matrix computation unit according to the embodiment;

FIG. 11 is a diagram illustrating connections within the matrix computation unit during the forward process;

FIG. 12 is a diagram illustrating connections within the matrix computation unit during the backward process;

FIG. 13 is a diagram illustrating a flow of a process of the neural network device according to the embodiment;

FIG. 14 is a diagram illustrating a first circuit example of the matrix computation unit and illustrating connections for the forward process;

FIG. 15 is a diagram illustrating the first circuit example of the matrix computation unit and illustrating connections for the backward process;

FIG. 16 is a diagram illustrating a second circuit example of the matrix computation unit;

FIG. 17 is a diagram illustrating a third circuit example of the matrix computation unit; and

FIG. 18 is a diagram illustrating a fourth circuit example of the matrix computation unit.

### DETAILED DESCRIPTION

According to an embodiment, a neural network device includes a control unit, and a matrix computation unit. The control unit causes a plurality of layers, each of which executes a process, to execute a forward process of propagating a plurality of signal values in a forward direction, and a backward process of propagating a plurality of error values in a backward direction. The matrix computation unit performs computation on a plurality of values propagated at least some of interlayers in the plurality of layers. The plurality of layers includes a first layer and a second layer adjacent to the first layer in the forward direction. The matrix computation unit includes (m×n) multipliers, and an addition circuit. The (m×n) multipliers are provided in one-to-one correspondence with (m×n) coefficients included in a coefficient matrix of m rows and n columns (m and n are integers greater than or equal to one and, in a case where one of m and n is one, the other is greater than or equal to two). The addition circuit switches a pattern for adding values output from the respective (m×n) multipliers between the forward process and the backward process.

Hereinafter, a neural network device 10 according to an embodiment will be described with reference to the drawings. The neural network device 10 according to the embodiment executes a data propagation process (forward process) at the time of ordinary computation and a data propagation process (backward process) at the time of learning using common hardware.

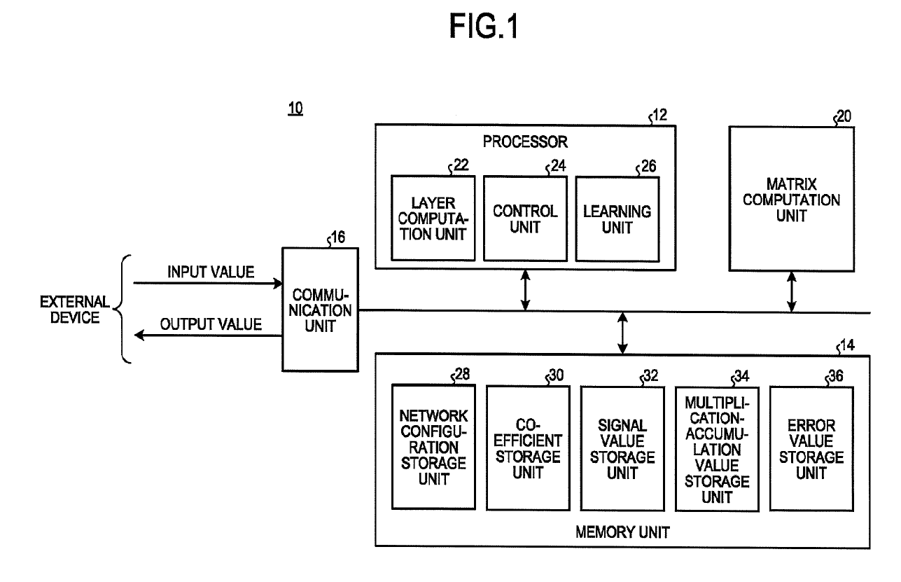

FIG. 1 is a diagram illustrating a configuration of the neural network device 10 according to the embodiment. The neural network device 10 includes a processor 12, a memory unit 14, a communication unit 16, and a matrix computation unit 20. The processor 12, the memory unit 14, the communication unit 16, and the matrix computation unit 20 are connected via, for example, a bus. The processor 12, the memory unit 14, the communication unit 16, and the matrix computation unit 20 may be mounted on one semiconductor device, or may be mounted on a plurality of semiconductor devices provided on one substrate, or may be mounted on a plurality of semiconductor devices provided on a plurality of substrates.

The neural network device 10 receives one or a plurality of input values from an external device. The neural network device 10 executes a computation process using a neural network on the acquired one or plurality of input values. Then, the neural network device 10 transmits one or a plurality of output values, which is the result of the computation process using the neural network, to the external device.

The external device may be a functional block mounted on the same semiconductor device as the neural network device 10, or may be another semiconductor device provided on the same substrate, or may be a semiconductor device provided on a different substrate. Alternatively, the external device may be a separate device connected to the neural network device 10 via a network cable, a wireless transmission path, or the like.

The neural network device 10 executes an ordinary computation process. For example, the neural network device 10 executes various information processes such as a pattern recognition process, a data analysis process, and a control process as the ordinary computation processes.

Furthermore, the neural network device 10 executes a learning process in parallel with the ordinary computation process. The neural network device 10 changes a plurality of coefficients (weights) included in the neural network through the learning process so as to more properly perform the ordinary computation process. Note that the neural network device 10 may or may not transmit the result of the learning process to the external device.

The processor 12 is, for example, a central processing unit (CPU) or a graphics processing unit (GPU) and executes a program to implement a predetermined computation function, control function, and the like. The program executed by the processor 12 is saved in a storage medium or the like and the processor 12 reads the program from the storage medium to execute. In addition, the program executed by the processor 12 may be saved in a read only memory (ROM) or the like incorporated in the neural network device 10. Furthermore, the processor 12 may be dedicated hardware specialized for the computation process using the neural network.

The processor 12 implements the functions of a layer computation unit 22, a control unit 24, and a learning unit 26. The layer computation unit 22 executes a process corresponding to a plurality of layers included in the neural network.

Each of the plurality of layers performs predetermined computation and process on one or a plurality of values that has been input. Then, each of the plurality of layers outputs one or a plurality of values as a result of the computation and the process. Specifically, at the time of ordinary computation, each of the plurality of layers executes computation of an activation function or the like for one or a plurality of values that has been input (a plurality of signal values). At the time of learning, each of the plurality of layers executes computation of an error function (derivative of the activation function) and the like.

The control unit 24 performs control to propagate one or a plurality of values to the plurality of layers included in the neural network. Specifically, at the time of ordinary computation, the control unit 24 supplies one or a plurality of input values received from the external device to an input layer among the plurality of layers. Subsequently, at the time of ordinary computation, the control unit 24 executes a forward process of propagating the plurality of signal values output from each layer to an immediately following layer in a forward direction. Then, at the time of ordinary computation, the control unit 24 acquires one or a plurality of output values output from an output layer among the plurality of layers to transmit to the external device.

Meanwhile, at the time of learning, the control unit 24 supplies one or a plurality of error values generated by the learning unit 26 to the output layer among the plurality of layers. Then, at the time of learning, the control unit 24 executes a backward process of propagating the plurality of error values output from each layer to an immediately preceding layer in a backward direction.

At the time of ordinary computation, the learning unit 26 acquires one or a plurality of output values output from the output layer. Then, the learning unit 26 calculates one or a plurality of error values representing errors of the one or plurality of output values.

Furthermore, the learning unit 26 acquires a value obtained as a result of executing the backward process from the layer computation unit 22 and changes a plurality of coefficients (weights) included in the neural network such that one or a plurality of error values to be propagated to each layer in the backward process becomes smaller. For example, the learning unit 26 calculates the gradient of the error value for each of the plurality of coefficients included in the neural network. Then, the learning unit 26 changes the plurality of coefficients in a direction in which the gradient of the error value is adjusted to, for example, zero.

The memory unit 14 is, for example, a semiconductor storage device. The memory unit 14 functions as a network configuration storage unit 28, a coefficient storage unit 30, a signal value storage unit 32, a multiplication-accumulation value storage unit 34, and an error value storage unit 36.

The network configuration storage unit 28 stores information representing the configuration of the neural network implemented by the neural network device 10. For example, the network configuration storage unit 28 stores a link relationship of each interlayer (between two adjacent layers) of the plurality of layers. The network configuration storage unit 28 also stores, for example, the types of the activation functions to be executed in each of the plurality of layers in the forward process and the types of the error functions executed in each of the plurality of layers in the backward process. The control unit 24 refers to the information stored in the network configuration storage unit 28 to execute the forward process and the backward process. In addition, the layer computation unit 22 refers to the information stored in the network configuration storage unit 28 to execute computation and a process corresponding to each layer.

The coefficient storage unit 30 stores the plurality of coefficients included in the neural network. The matrix computation unit 20 acquires a plurality of values from the coefficient storage unit 30. Note that also the matrix computation unit 20 may store the plurality of coefficients. In this case, the memory unit 14 may not function as the coefficient storage unit 30.

The signal value storage unit 32 stores a plurality of signal values output from each of the plurality of layers in the forward process. The multiplication-accumulation value storage unit 34 stores a plurality of multiplication-accumulation values supplied to each of the plurality of layers in the forward process. The error value storage unit 36 stores a plurality of error values output from each of the plurality of layers in the backward process.

The communication unit 16 exchanges information with the external device. Specifically, the communication unit 16 receives one or a plurality of input values to be computed from the external device. In addition, the communication unit 16 transmits one or a plurality of output values, which are computation results, to the external device.

The matrix computation unit 20 executes matrix multiplication using a coefficient matrix. In the present embodiment, the matrix computation unit 20 is a hardware circuit different from the processor 12.

In the neural network, the coefficient matrix is set for each interlayer of the plurality of layers. The coefficient matrix is appropriately changed at the time of learning. When executing the forward process and the backward process, the matrix computation unit 20 performs, for each interlayer, matrix multiplication between a plurality of values (the plurality of signal values or the plurality of error values) output from a previous layer and the coefficient matrix set in correspondence with each interlayer.

In addition, the matrix computation unit 20 executes matrix multiplication for the same interlayer using a common coefficient matrix in the forward process and the backward process.

Note that the matrix computation unit 20 may execute matrix multiplication for all of the plurality of interlayers or may execute matrix multiplication for some interlayers among the plurality of interlayers. When the matrix computation unit 20 executes matrix multiplication for some interlayers among the plurality of interlayers, another device (for example, the processor 12) executes matrix multiplication for the other interlayers.

In addition, the matrix computation unit 20 may be divided into a plurality of hardware units. For example, the matrix computation unit 20 may be implemented by different hardware for each interlayer. Furthermore, in addition to the matrix multiplication between the coefficient matrix and the plurality of signal values (or the plurality of error values), the matrix computation unit 20 may execute matrix addition for adding a bias matrix.

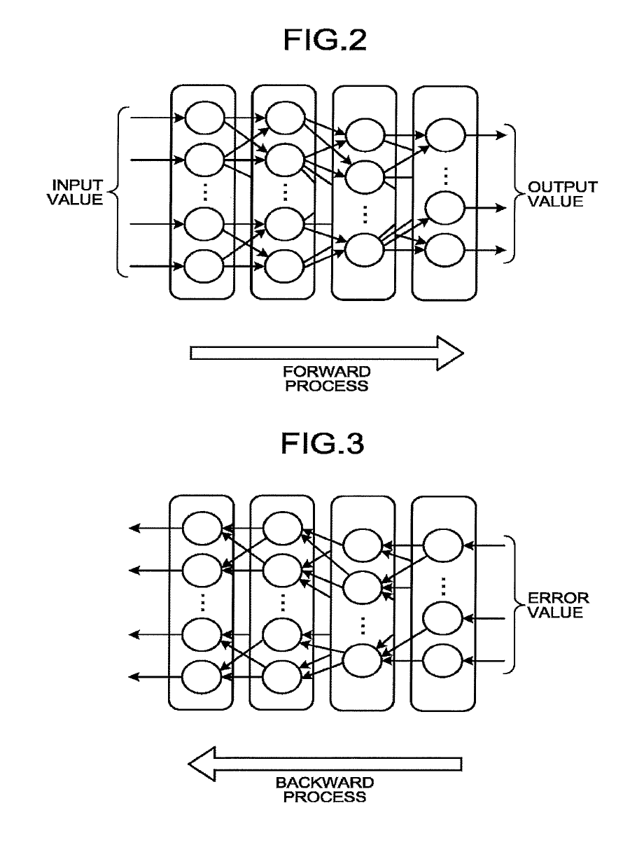

FIG. 2 is a diagram illustrating the contents of the forward process. Each of the plurality of layers included in the neural network includes a plurality of nodes. The number of nodes included in one layer may be different for each layer. In addition, the activation function is set for each node. The activation function may be different for each layer. In addition, the activation function may be different for each node in the same layer.

In the forward process, the control unit 24 supplies one or a plurality of input values to the input layer. Subsequently, in the forward process, the control unit 24 propagates the plurality of signal values output from each layer to an immediately following layer in the forward direction. Then, in the forward process, the control unit 24 transmits one or a plurality of signals output from the output layer to the external device as one or a plurality of output values.

FIG. 3 is a diagram illustrating the contents of the backward process. The error function is set for each node. The error function is a derivative of the activation function set for each node. That is, the error function is a differentiation of the activation function set for each node. Note that the error function may be a function approximating the derivative of the activation function.

When the forward process is finished, the learning unit 26 calculates one or a plurality of error values representing errors with respect to each of one or a plurality of output values output in the forward process. Subsequently, in the backward process, the control unit 24 supplies the one or plurality of error values generated by the learning unit 26 to the output layer. Then, in the backward process, the control unit 24 propagates the plurality of error values output from each layer to an immediately preceding layer in the backward direction.

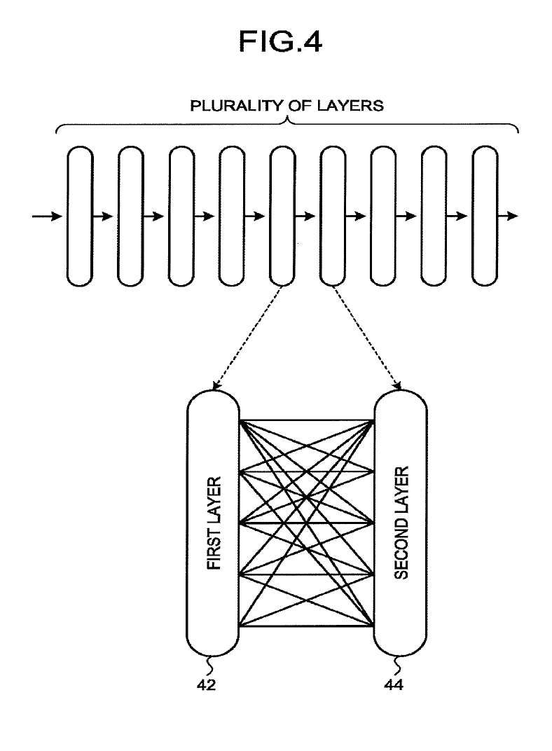

FIG. 4 is a diagram illustrating a first layer 42 and a second layer 44 included in the plurality of layers. In the present embodiment, an arbitrary layer among the plurality of layers in the neural network is defined as the first layer 42. In addition, among the plurality of layers, a layer adjacent to the first layer 42 in the forward direction is defined as the second layer 44. In the present embodiment, the plurality of layers includes such a first layer 42 and a second layer 44.

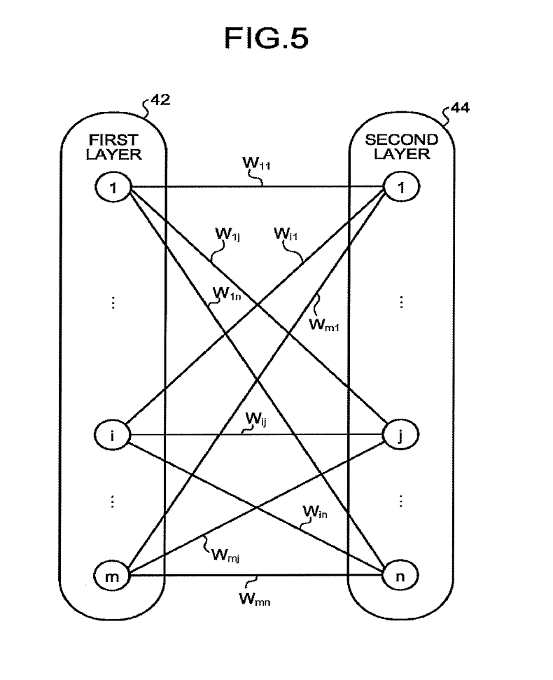

FIG. 5 is a diagram illustrating links between the first layer 42 and the second layer 44. The first layer 42 has m nodes. Meanwhile, the second layer 44 has n nodes. In addition, m and n are integers greater than or equal to one. However, when one of m and n is one, the other is greater than or equal to two.

Between the first layer 42 and the second layer 44, there are (m×n) links connecting all of the m nodes included in the first layer 42 and all of the n nodes included in the second layer 44. The coefficients (weights) are set for each of the (m×n) links.

In the present embodiment, a coefficient of the link between an i-th node of the first layer 42 and a j-th node of the second layer 44 is expressed as Wᵢⱼ. i represents an arbitrary integer greater than or equal to one and less than or equal to m. j represents an arbitrary integer greater than or equal to one and less than or equal to n.

(m×n) coefficients set for the (m×n) links between the first layer 42 and the second layer 44 are expressed as a coefficient matrix of m rows and n columns. The coefficient matrix is expressed by following formula (1).

$$( \begin{matrix}{W}_{11} & {W}_{12} & … & {W}_{1 j} & … & {W}_{1 n} \\ {W}_{21} & {W}_{22} & … & {W}_{2 j} & … & {W}_{2 n} \\ ⋮ & ⋮ & & ⋮ & & ⋮ \\ {W}_{i 1} & {W}_{i 2} & … & {W}_{ij} & … & {W}_{in} \\ ⋮ & ⋮ & & ⋮ & & ⋮ \\ {W}_{m 1} & {W}_{m 2} & … & {W}_{mj} & … & {W}_{mn}\end{matrix} ) \qquad ( 1 )$$

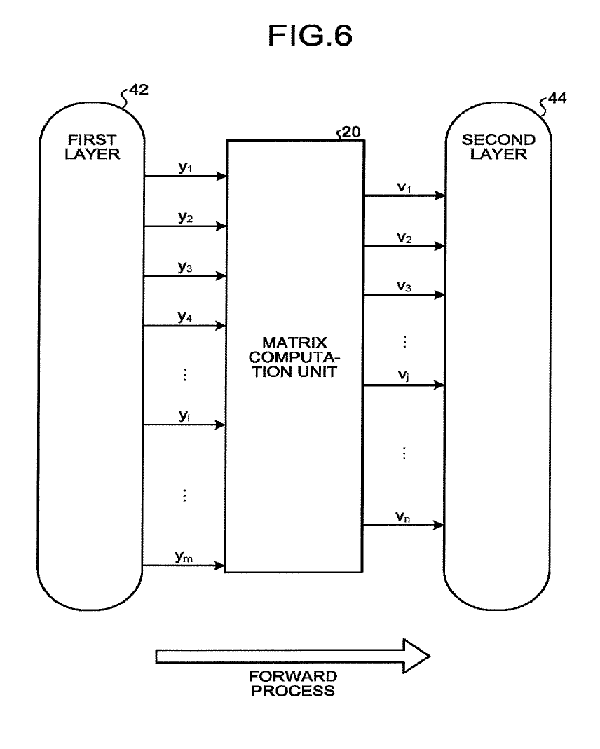

FIG. 6 is a diagram illustrating values input to and output from the matrix computation unit 20 in the forward process. In the forward process, the first layer 42 outputs m first signal values associated one-to-one with m rows of the coefficient matrix. In the forward process, the control unit 24 supplies the m first signal values output from the first layer 42 to the matrix computation unit 20.

In the forward process, the matrix computation unit 20 acquires the m first signal values output from the first layer 42. In the forward process, the matrix computation unit 20 performs matrix multiplication between the acquired m first signal values and an applicable matrix to output n forward multiplication-accumulation values associated one-to-one with n columns of the coefficient matrix. In the forward process, the control unit 24 supplies the n forward multiplication-accumulation values output from the matrix computation unit 20 to the second layer 44. Then, in the forward process, the second layer 44 acquires the n forward multiplication-accumulation values output from the matrix computation unit 20.

In the present embodiment, the m first signal values are expressed as y₁, . . . , yᵢ, . . . , and yₘ. The n forward multiplication-accumulation values are expressed as v₁, . . . , vⱼ, . . . , and vₙ. In this case, in the forward process, matrix multiplication executed by the matrix computation unit 20 can be expressed by following formula (2).

$$( {y}_{1} … {y}_{i} … {y}_{m} ) ( \begin{matrix}{W}_{11} & … & {W}_{1 j} & … & {W}_{1 n} \\ ⋮ & & ⋮ & & ⋮ \\ {W}_{i 1} & … & {W}_{ij} & … & {W}_{in} \\ ⋮ & & ⋮ & & ⋮ \\ {W}_{m 1} & … & {W}_{mj} & … & {W}_{mn}\end{matrix} ) = ( {v}_{1} … {v}_{j} … {v}_{n} ) \qquad ( 2 )$$

The m first signal values correspond to a matrix of one row and m columns (forward first matrix). In addition, the n forward multiplication-accumulation values correspond to a matrix of one row and n columns (forward second matrix).

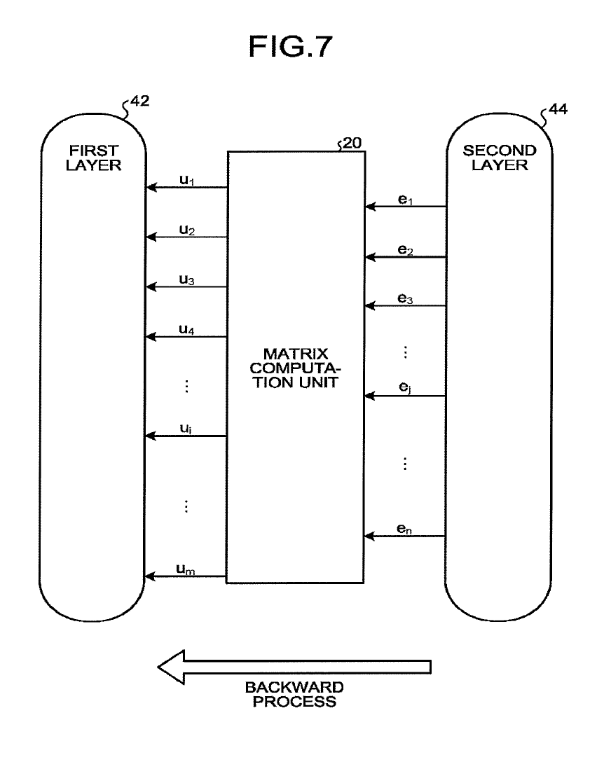

FIG. 7 is a diagram illustrating values input to and output from the matrix computation unit 20 in the backward process. In the backward process, the second layer 44 outputs n first error values associated one-to-one with the n columns of the coefficient matrix. In the backward process, the control unit 24 supplies the n first error values output from the second layer 44 to the matrix computation unit 20.

In the backward process, the matrix computation unit 20 acquires the n first error values output from the second layer 44. In the backward process, the matrix computation unit 20 performs matrix multiplication between an applicable matrix and the acquired n first error values to output m backward multiplication-accumulation values associated one-to-one with the m rows of the coefficient matrix. In the backward process, the control unit 24 supplies the m backward multiplication-accumulation values output from the matrix computation unit 20 to the first layer 42. Then, in the backward process, the first layer 42 acquires the m backward multiplication-accumulation values output from the matrix computation unit 20.

In the present embodiment, the n first error values are expressed as e₁, eⱼ, . . . , and eₙ. The m backward multiplication-accumulation values are expressed as u₁, . . . , uⱼ, . . . , and uₘ. In this case, in the backward process, matrix multiplication executed by the matrix computation unit 20 can be expressed by following formula (3).

$$( \begin{matrix}{W}_{11} & … & {W}_{1 j} & … & {W}_{1 n} \\ ⋮ & & ⋮ & & ⋮ \\ {W}_{i 1} & … & {W}_{ij} & … & {W}_{in} \\ ⋮ & & ⋮ & & ⋮ \\ {W}_{m 1} & … & {W}_{mj} & … & {W}_{mn}\end{matrix} ) ( \begin{matrix}{e}_{1} \\ ⋮ \\ {e}_{j} \\ ⋮ \\ {e}_{n}\end{matrix} ) = ( \begin{matrix}{u}_{1} \\ ⋮ \\ {u}_{i} \\ ⋮ \\ {u}_{m}\end{matrix} ) \qquad ( 3 )$$

The n first error values correspond to a matrix of n rows and one column (backward first matrix). In addition, the m backward multiplication-accumulation values correspond to a matrix of m rows and one column (backward second matrix).

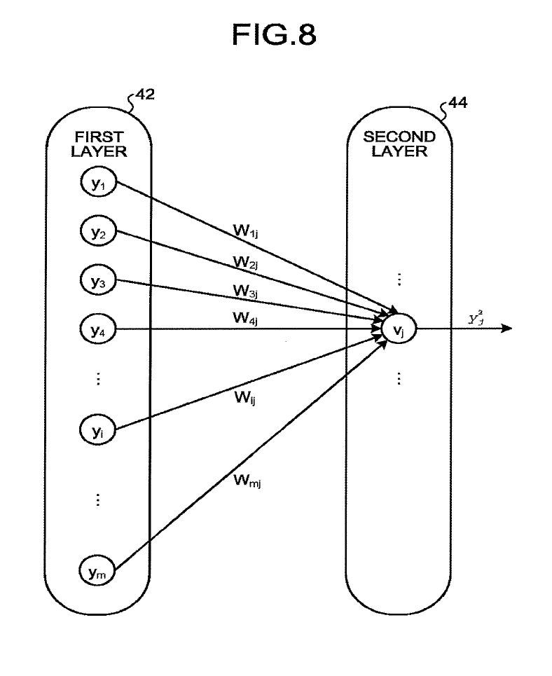

FIG. 8 is a diagram illustrating the contents of computation executed in the matrix computation unit 20 and the layer computation unit 22 in the forward process.

In the forward process, the matrix computation unit 20 executes computation indicated by following formula (4) to calculate the forward multiplication-accumulation value (vⱼ) corresponding to the j-th column.

$${v}_{j} = {\sum }_{i = 1}^{m} {W}_{ij} \cdot {Y}_{i} \qquad ( 4 )$$

That is, the matrix computation unit 20 multiplies the coefficients and the first signal values for each row for the j-th column of the coefficient matrix to calculate m multiplication values (W₁ⱼ·y₁, . . . , W₁ⱼ·yᵢ, . . . , and Wₘⱼ·yₘ). Then, the matrix computation unit 20 adds the calculated m multiplication values for the j-th column of the coefficient matrix. Consequently, the matrix computation unit 20 can calculate the forward multiplication-accumulation value (vⱼ) corresponding to the j-th column.

The matrix computation unit 20 executes such multiplication-accumulation (product-sum operation) for each of the n columns included in the coefficient matrix. Consequently, the matrix computation unit 20 can calculate the n forward multiplication-accumulation values.

Subsequently, in the forward process, the second layer 44 executes computation indicated by following formula (5) to calculate a second signal value (y²ⱼ) corresponding to the j-th column. Note that the activation function corresponding to the j-th column of the second layer 44 is expressed by ϕⱼ( ).

yⱼ²=ϕⱼ(vⱼ) (5)

That is, the second layer 44 supplies the forward multiplication-accumulation value (vⱼ) corresponding to the j-th column to the activation function corresponding to the j-th column to calculate the second signal value (y²ⱼ) corresponding to the j-th column.

The second layer 44 executes computation of such an activation function for each of the n columns. Consequently, the second layer 44 can calculate n second signal values (y²₁, . . . , y²ⱼ, . . . , and y²ₙ).

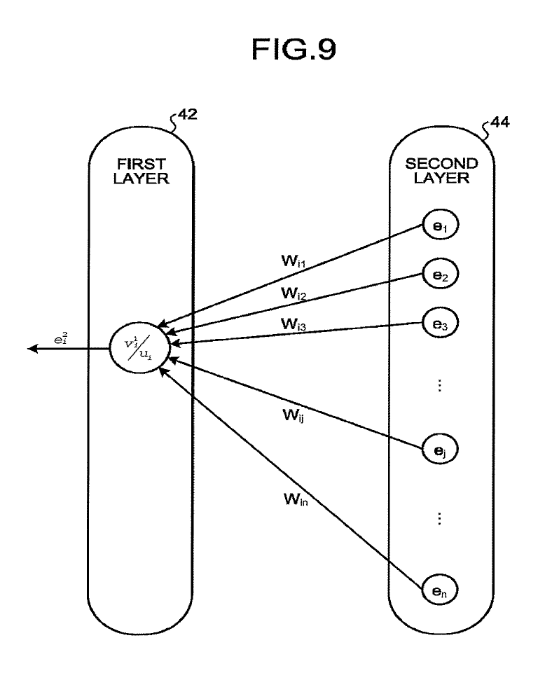

FIG. 9 is a diagram illustrating the contents of computation executed in the matrix computation unit 20 and the layer computation unit 22 in the backward process.

In the backward process, the matrix computation unit 20 executes computation indicated by following formula (6) to calculate the backward multiplication-accumulation value (uᵢ) corresponding to the i-th row.

$${u}_{i} = {\sum }_{j = 1}^{n} {e}_{j} \cdot {W}_{ij} \qquad ( 6 )$$

That is, the matrix computation unit 20 multiplies the coefficients and the first error values for each column for the i-th row of the coefficient matrix to calculate n multiplication values (e₁·Wᵢ₁, . . . , eⱼ·Wᵢⱼ, . . . , and eₙ·Wᵢₙ). Then, the matrix computation unit 20 adds the calculated n multiplication values for the i-th row of the coefficient matrix. Consequently, the matrix computation unit 20 can calculate the backward multiplication-accumulation value (uᵢ) corresponding to the i-th row.

The matrix computation unit 20 executes such multiplication-accumulation (product-sum operation) for each of the m rows included in the coefficient matrix. Consequently, the matrix computation unit 20 can calculate the m backward multiplication-accumulation values.

In addition, the first layer 42 has received m previous multiplication-accumulation values from the matrix computation unit 20 in the forward process corresponding to the current backward process. The m previous multiplication-accumulation values are values calculated by the matrix computation unit 20 when the plurality of signal values is propagated from a previous layer of the first layer 42 to the first layer 42 in the forward process. That is, the m previous multiplication-accumulation values are m values that the first layer 42 has supplied to the activation function to calculate the m first signal values (y₁, . . . , yᵢ, . . . , and yₘ) in the forward process. In the present embodiment, the m previous multiplication-accumulation values are expressed as V¹₁, . . . , V¹ᵢ, . . . , and v¹ₘ.

Subsequently, in the backward process, the first layer 42 executes computation indicated by following formula (7) to calculate a second error value (e²ᵢ) corresponding to the i-th row. Note that the error function corresponding to the i-th row of the first layer 42 is expressed as ϕ′ᵢ( ).

eᵢ²=ϕ′ᵢ(vᵢ¹)·uᵢ (7)

That is, the first layer 42 supplies the previous multiplication-accumulation value (v¹ᵢ) corresponding to the i-th row to the error function corresponding to the i-th row to calculate an inverse transform value (ϕ′ᵢ(v¹ᵢ)) corresponding to the i-th row. Furthermore, the second layer 44 multiplies the inverse transform value (ϕ′ᵢ(v¹ᵢ)) corresponding to the i-th row by the backward multiplication-accumulation value (uᵢ) corresponding to the i-th row to calculate the second error value (e²ᵢ) corresponding to the i-th row.

The first layer 42 executes computation of such an error function for each of the m rows. Consequently, the first layer 42 can calculate m second error values (e²₁, . . . , e²ᵢ, . . . , and e²ₘ).

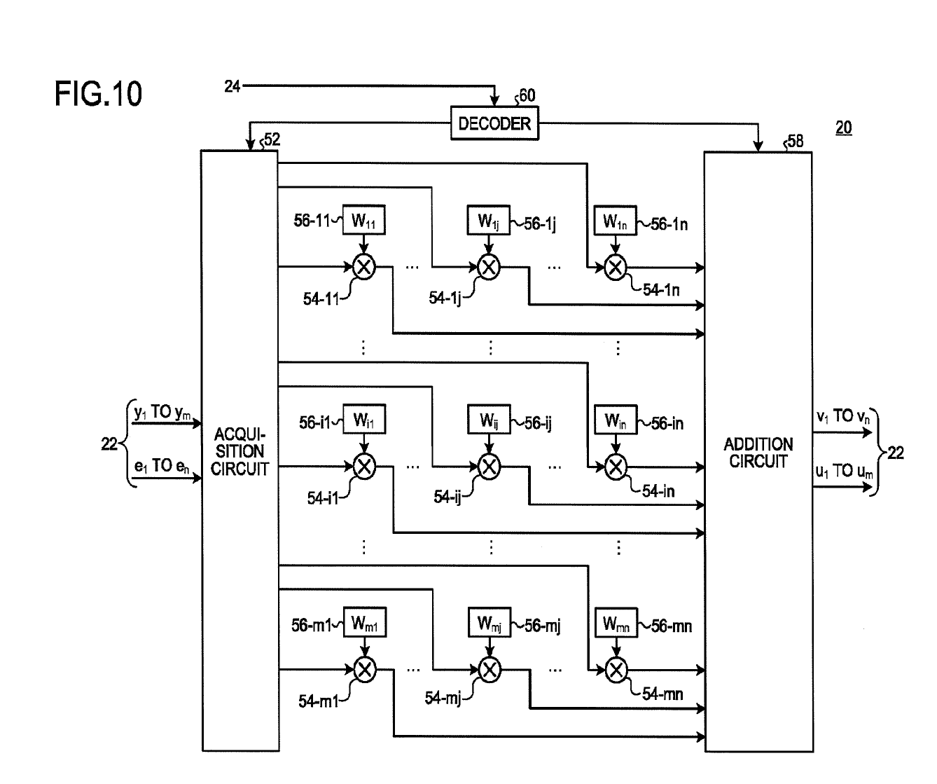

FIG. 10 is a diagram illustrating a configuration of the matrix computation unit 20 according to the embodiment. The matrix computation unit 20 includes a circuit as illustrated in FIG. 10 as a circuit configuration for executing matrix multiplication for an interlayer between the first layer 42 and the second layer 44 among the plurality of layers included in the neural network. The matrix computation unit 20 also includes circuits equivalent to that in FIG. 10 for each of one or more interlayers other than the interlayer between the first layer 42 and the second layer 44.

The matrix computation unit 20 has an acquisition circuit 52, (m×n) multipliers 54, (m×n) coefficient memories 56, an addition circuit 58, and a decoder 60.

In the forward process, the acquisition circuit 52 acquires the m first signal values (y₁ to yₘ) from the layer computation unit 22. The m first signal values (y₁ to yₘ) are associated one-to-one with the m rows of the coefficient matrix. Meanwhile, in the backward process, the acquisition circuit 52 acquires the n first error values (e₁ to eₙ) from the layer computation unit 22. The n first error values (e₁ to eₙ) are associated one-to-one with the n columns of the coefficient matrix.

The (m×n) multipliers 54 are provided in a one-to-one correspondence with the (m×n) coefficients included in the coefficient matrix. For example, the multiplier 54-ij is associated with the coefficient (Wᵢⱼ) of the i-th row and the j-th column.

In the forward process, each of the (m×n) multipliers 54 multiplies the first signal value corresponding to the row with which each multiplier 54 is associated among the m first signal values and the coefficient with which each multiplier 54 is associated among the (m×n) coefficients included in the coefficient matrix. For example, in the forward process, the multiplier 54-ij associated with the coefficient (Wᵢⱼ) of the i-th row and the j-th column multiplies the first signal value (yᵢ) associated with the i-th row of the coefficient matrix and the coefficient (Wᵢⱼ) of the i-th row and the j-th column included in the coefficient matrix.

In the backward process, each of the (m×n) multipliers 54 multiplies the first error value corresponding to the column with which each multiplier 54 is associated among the n first error values and the coefficient with which each multiplier 54 is associated among the (m×n) coefficients included in the coefficient matrix. For example, in the backward process, the multiplier 54-ij associated with the coefficient (Wᵢⱼ) of the i-th row and the j-th column multiplies the first error value (eⱼ) associated with the j-th column of the coefficient matrix and the coefficient (Wᵢⱼ) of the i-th row and the j-th column included in the coefficient matrix.

Each of the (m×n) multipliers 54 is implemented by hardware. The multiplier 54 may be, for example, an analog multiplication circuit for multiplying an analog signal or may be a digital multiplication circuit for multiplying a digital signal.

The (m×n) coefficient memories 56 are provided in a one-to-one correspondence with the (m×n) coefficients included in the coefficient matrix of m rows and n columns. For example, the coefficient memory 56-ij is associated with the coefficient (Wᵢⱼ) of the i-th row and the j-th column.

Each of the (m×n) coefficient memories 56 stores the associated coefficient and supplies the stored coefficient to the corresponding multiplier 54. For example, the coefficient memory 56-ij stores the coefficient (Wᵢⱼ) of the i-th row and the j-th column and supplies the coefficient (Wᵢⱼ) to the multiplier 54-ij.

The coefficient is written to each of the (m×n) coefficient memories 56 by the learning unit 26. At the time of initial operation (for example, when shipped from the factory), each of the (m×n) coefficient memories 56 may store a coefficient having a predetermined value.

Note that each of the (m×n) multipliers 54 may have a storage function for storing the coefficient. In this case, the matrix computation unit 20 may have a configuration not including the (m×n) coefficient memories 56.

For example, the multiplier 54 may be a resistor whose conductance can be changed. In this case, the conductance is set as the coefficient such that the multiplier 54 can store the coefficient. A voltage according to the first signal value (or the first error value) is applied to such a multiplier 54. Then, the multiplier 54 outputs the current value as a multiplication value obtained by multiplying the first signal value (or the first error value) and the coefficient.

Alternatively, the multiplier 54 may be a capacitance device whose capacitance can be changed. In this case, the capacitance is set as the coefficient such that the multiplier 54 can store the coefficient. A voltage according to the first signal value (or the first error value) is applied to such a multiplier 54. Then, the multiplier 54 as described above outputs the accumulated charge amount as a multiplication value obtained by multiplying the first signal value (or the first error value) and the coefficient.

In the forward process, the addition circuit 58 adds (m×n) multiplication values output from the (m×n) multipliers 54 for each column to calculate the n forward multiplication-accumulation values (v₁ to vₙ). Then, in the forward process, the addition circuit 58 outputs the calculated n forward multiplication-accumulation values (v₁ to vₙ) to the layer computation unit 22.

In the backward process, the addition circuit 58 adds (m×n) multiplication values output from the (m×n) multipliers 54 for each row to calculate the m backward multiplication-accumulation values (u₁ to uₘ). Then, in the backward process, the addition circuit 58 outputs the calculated m backward multiplication-accumulation values (u₁ to uₘ) to the layer computation unit 22.

The decoder 60 accepts an instruction from the control unit 24 as to which of the forward process and the backward process is to be executed. When the forward process is designated, the decoder 60 may further accept designation from the control unit 24 as to which column is to be used for outputting the forward multiplication-accumulation value corresponding thereto. Meanwhile, when the backward process is designated, the decoder 60 may further accept designation from the control unit 24 as to which column is to be used for outputting the backward multiplication-accumulation value corresponding thereto.

The decoder 60 controls the acquisition circuit 52 according to the accepted instruction to switch which value is to be supplied to each of the (m×n) multipliers 54. The decoder 60 also controls the addition circuit 58 according to the accepted instruction to switch the pattern for adding the (m×n) values output from the (m×n) multipliers 54.

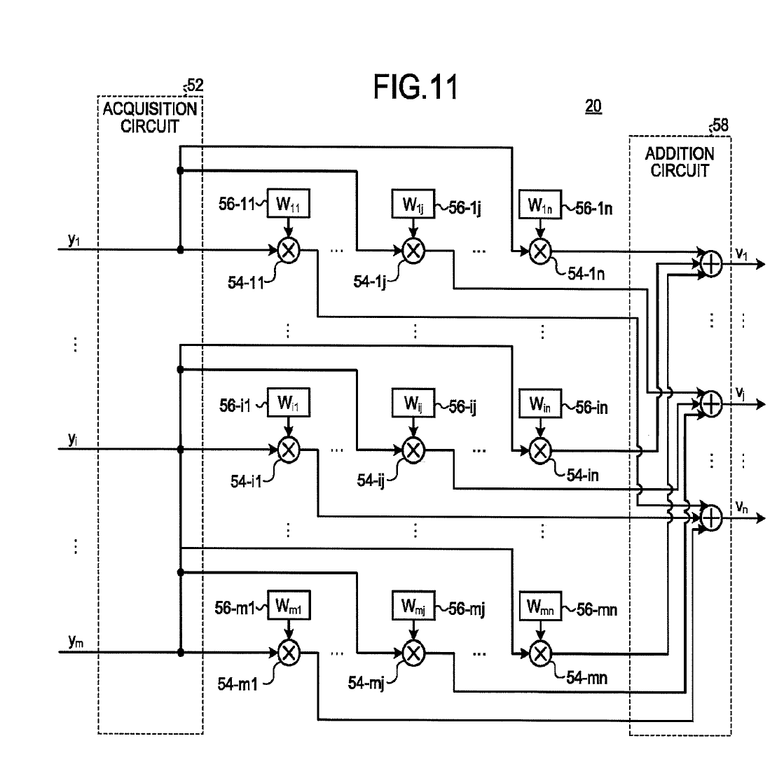

FIG. 11 is a diagram illustrating connections within the matrix computation unit 20 during the forward process. In the forward process, the acquisition circuit 52 supplies the first signal value (yᵢ) corresponding to the i-th row among the m first signal values (y₁ to yₘ) to the n multipliers 54-i1 to 54-in associated with the n coefficients included in the i-th row of the coefficient matrix.

In the forward process, the addition circuit 58 adds the m multiplication values output from the m multipliers 54-1j to 54-mj associated with the m coefficients included in the j-th column of the coefficient matrix to calculate the forward multiplication-accumulation value (vⱼ) corresponding to the j-th column. By executing the above process, in the forward process, the addition circuit 58 adds the (m×n) multiplication values output from the (m×n) multipliers 54 for each column, thereby being able to calculate the n forward multiplication-accumulation values (v₁ to vₙ).

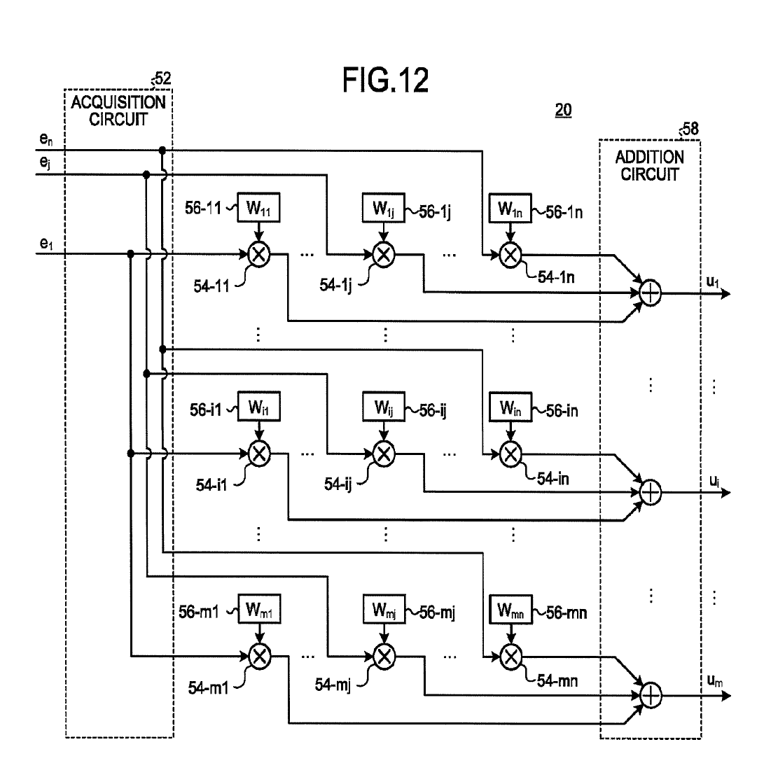

FIG. 12 is a diagram illustrating connections within the matrix computation unit 20 during the backward process. In the backward process, the acquisition circuit 52 supplies the first error value (eⱼ) corresponding to the j-th column among the n first error values (e₁ to eₙ) to the m multipliers 54-1j to 54-mj associated with the m coefficients included in the j-th column of the coefficient matrix.

In the backward process, the addition circuit 58 adds the n multiplication values output from the n multipliers 54-i1 to 54-in associated with the n coefficients included in the i-th column of the coefficient matrix to calculate the backward multiplication-accumulation value (uᵢ) corresponding to the i-th column. By executing the above process, in the backward process, the addition circuit 58 adds the (m×n) multiplication values output from the (m×n) multipliers 54 for each row, thereby being able to calculate the m backward multiplication-accumulation values (u₁ to uₘ).

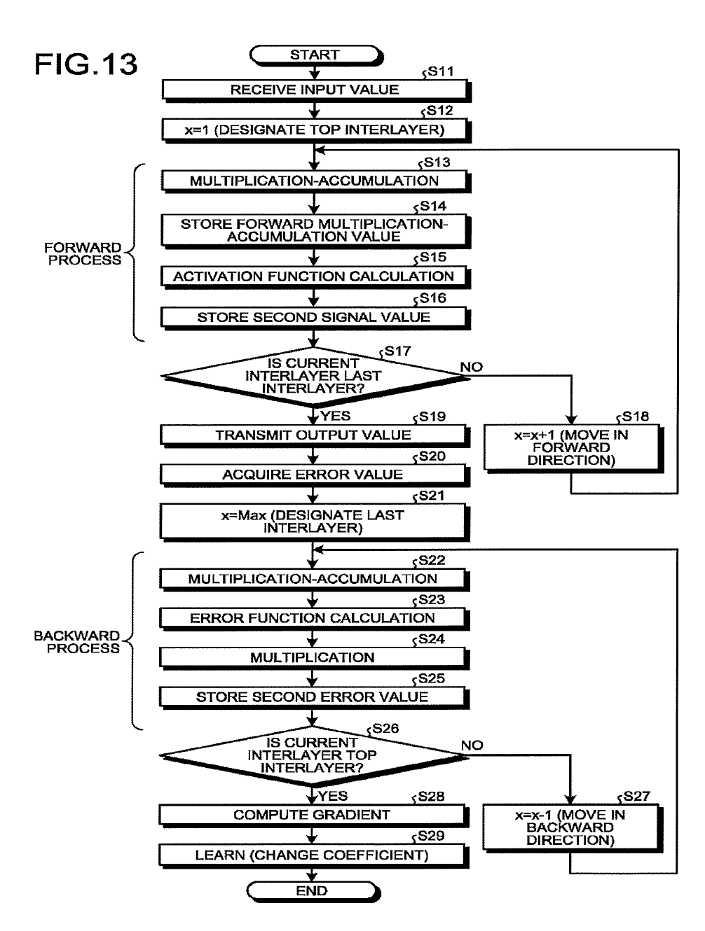

FIG. 13 is a flowchart illustrating a flow of a process of the neural network device 10 according to the embodiment. The neural network device 10 executes the process along the flow as illustrated in FIG. 13.

First, in S11, the communication unit 16 receives one or a plurality of input values from an external device. The control unit 24 supplies the received one or plurality of input values to a top layer in the plurality of layers included in the neural network. Note that, in this example, it is assumed that the top layer in the neural network merely acquires signals and does not perform a computation process.

Subsequently, in S12, the control unit 24 substitutes one for a variable x designating the interlayer. Then, the control unit 24 executes the following forward process in S13 to S16, with the previous layer of the designated interlayer as the first layer 42 and the subsequent layer thereof as the second layer 44.

In S13, the control unit 24 supplies the m first signal values output from the first layer 42 to the matrix computation unit 20. The matrix computation unit 20 performs matrix multiplication between the supplied m first signal values and the coefficient matrix set for the designated interlayer to calculate the n forward multiplication-accumulation values. Subsequently, in S14, the control unit 24 stores the calculated n forward multiplication-accumulation values to the multiplication-accumulation value storage unit 34 in correspondence with the number (variable x) designating the interlayer.

Subsequently, in S15, the control unit 24 supplies the calculated n forward multiplication-accumulation values to the layer computation unit 22. The layer computation unit 22 supplies each of the supplied n forward multiplication-accumulation values to the activation function set for the second layer 44 to calculate the n second signal values. Subsequently, in S16, the control unit 24 stores the calculated n second signal values to the signal value storage unit 32 in correspondence with the number (variable x) designating the interlayer.

Subsequently, in S17, the control unit 24 determines whether the process has been completed up to the last interlayer of the plurality of layers.

When the process has not been completed up to the last interlayer (No in S17), the control unit 24 advances the process to S18. In S18, the control unit 24 adds one to the number (variable x) designating the interlayer and moves the interlayer to be processed by one interlayer in the forward direction. Then, the control unit 24 returns the process to S13. In this case, the control unit 24 defines the previous layer of the interlayer after being moved in the forward direction as the first layer 42 and the subsequent layer thereof as the second layer 44. Furthermore, the control unit 24 replaces the n second signal values calculated in S15 with the m first signal values and executes the following forward process in S13 to S16.

When the process has been completed up to the last interlayer (Yes in S17), the control unit 24 advances the process to S19. In S19, the communication unit 16 transmits the m second signal values calculated in the process for the immediately preceding interlayer to the external device as one or a plurality of output values. Note that, in this example, it is assumed that the last layer in the neural network merely outputs signals and does not perform a computation process.

Subsequently, in S20, the control unit 24 acquires one or a plurality of error values representing errors of the one or plurality of output values transmitted to the external device. The control unit 24 may cause the learning unit 26 to calculate the one or plurality of error values or may receive the one or plurality of error values from an information processing device provided outside the neural network device 10.

Subsequently, in S21, the control unit 24 substitutes max representing the number of interlayers of the neural network for the variable x designating the interlayer of the plurality of layers. Then, the control unit 24 executes the following backward process in S22 to S25, with the previous layer of the designated interlayer as the first layer 42 and the subsequent layer thereof as the second layer 44.

In S22, the control unit 24 supplies the n first error values output from the second layer 44 to the matrix computation unit 20. The matrix computation unit 20 performs matrix multiplication between the supplied n first error values and the coefficient matrix set for the designated interlayer to calculate the m backward multiplication-accumulation values. Then, the control unit 24 supplies the m backward multiplication-accumulation values calculated by the matrix computation unit 20 to the layer computation unit 22.

Subsequently, in S23, the control unit 24 reads the m forward multiplication-accumulation values stored in association with the interlayer designated by (x−1) (between the first layer 42 and the previous layer of the first layer 42 in the forward direction) from the multiplication-accumulation value storage unit 34. Then, the control unit 24 supplies the read m forward multiplication-accumulation values to the layer computation unit 22. Furthermore, the layer computation unit 22 supplies each of the supplied m forward multiplication-accumulation values to the error function set for the first layer 42 to calculate the m inverse transform values.

Subsequently, in S24, the layer computation unit 22 multiplies each of the supplied m backward multiplication-accumulation values and the inverse transform value of the corresponding row among the calculated m inverse transform values. Consequently, the layer computation unit 22 can calculate the m second error values.

Subsequently, in S25, the control unit 24 stores the calculated m second error values to the error value storage unit 36 in correspondence with the number (variable x) designating the interlayer.

Subsequently, in S26, the control unit 24 determines whether the process has been completed up to the top interlayer of the plurality of layers.

When the process has not been completed up to the top interlayer (No in S26), the control unit 24 advances the process to S27. In S27, the control unit 24 subtracts one from the number (variable x) designating the interlayer and moves the interlayer to be processed by one interlayer in the backward direction. Then, the control unit 24 returns the process to S22. In this case, the control unit 24 defines the previous layer of the interlayer after being moved in the backward direction as the first layer 42 and the subsequent layer thereof as the second layer 44. Furthermore, the control unit 24 replaces the m second error values calculated in S25 with the n first error values and executes the following backward process in S22 to S25.

When the process has been completed up to the top interlayer (Yes in S26), the control unit 24 advances the process to S28. In S28, the learning unit 26 calculates the gradient for each of the (m×n) coefficients included in the coefficient matrix. For example, based on the plurality of signal values for each interlayer stored in the signal value storage unit 32 and the plurality of error values for each interlayer stored in the error value storage unit 36, the learning unit 26 calculates the gradient for each of the plurality of coefficients.

Subsequently, in S29, the learning unit 26 changes the plurality of coefficients based on the calculated gradient. For example, the learning unit 26 changes each of the plurality of coefficients such that the gradient becomes smaller. For example, the learning unit 26 rewrites the plurality of coefficients stored in the coefficient storage unit 30. In addition, the learning unit 26 stores a plurality of changed coefficients to the coefficient storage unit 30.

Then, after the learning unit 26 completes the process in S29, the control unit 24 finishes this flow.

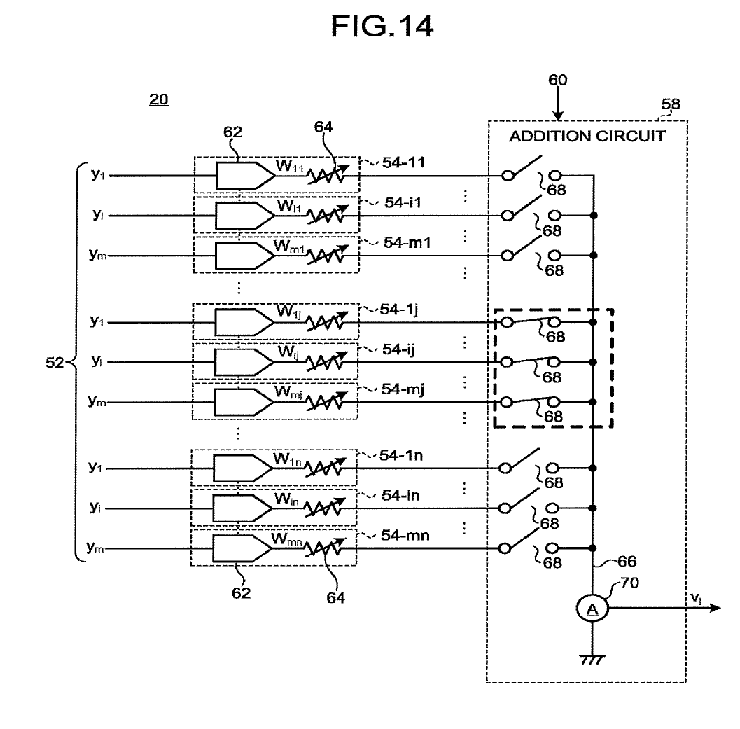

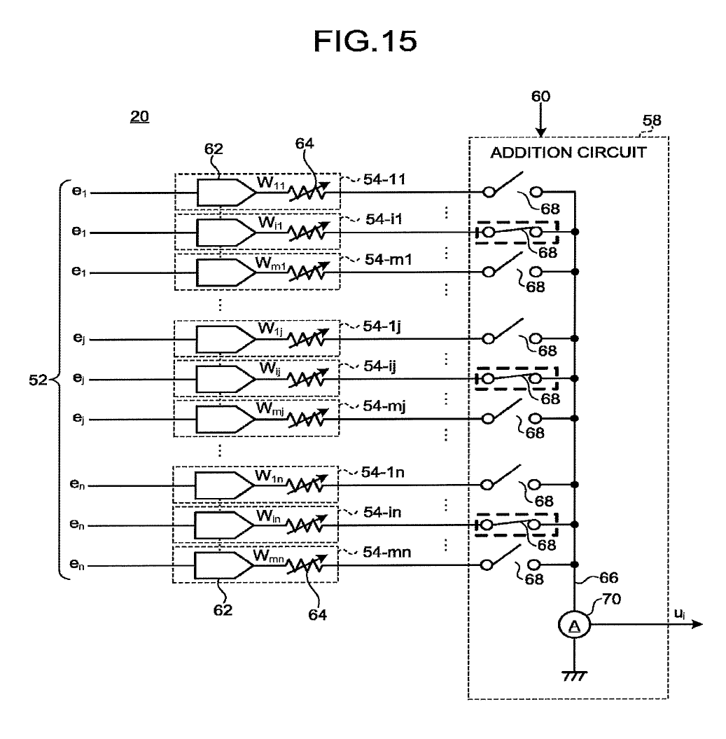

FIG. 14 is a diagram illustrating a first circuit example of the matrix computation unit 20 and illustrating connections in the case of performing the forward process. FIG. 15 is a diagram illustrating the first circuit example of the matrix computation unit 20 and illustrating connections in the case of performing the backward process. The matrix computation unit 20 may have the configuration indicated by the first circuit example as illustrated in FIGS. 14 and 15, for example.

Each of the (m×n) multipliers 54 according to the first circuit example includes a voltage generator 62 and a resistance change memory 64. The addition circuit 58 according to the first circuit example includes a common signal line 66, (m×n) switches 68, and a current detector 70.

The voltage generator 62 generates a voltage according to the value supplied from the acquisition circuit 52. A first end of the resistance change memory 64 is connected to an output end of the voltage generator 62. A second end of the resistance change memory 64, which is different from the first end, is connected to the common signal line 66 via the switch 68 provided in correspondence with the multiplier 54 including this resistance change memory 64.

The common signal line 66 is connected to a predetermined potential (for example, a ground potential or a common potential). The (m×n) switches 68 are provided in a one-to-one correspondence with the (m×n) multipliers 54. Each of the (m×n) switches 68 turns on (connect) or turns off (disconnect) the connection between the resistance change memory 64 included in the corresponding multiplier 54 and the common signal line 66 according to the control of the decoder 60. The current detector 70 detects the current flowing through the common signal line 66.

In the resistance change memory 64 included in each of the (m×n) multipliers 54, the conductance is set as the coefficient of an applicable matrix associated with each multiplier 54. For example, in the resistance change memory 64 included in the multiplier 54-ij, the conductance is set as the coefficient (Wᵢⱼ) of the i-th row and the j-th column.

As illustrated in FIG. 14, in the forward process, the first signal value (yᵢ) of the i-th row is supplied to the n voltage generators 62 included in the multipliers 54-i1, . . . , 54-ij, . . . , and 54-in of the i-th row. In the forward process, the decoder 60 controls switching of the (m×n) switches 68 so as to output the forward multiplication-accumulation values for each column. For example, in the case of outputting the forward multiplication-accumulation value of the j-th column, the decoder 60 turns on the m switches 68 associated with the multipliers 54-1j, 54-2j, . . . , 54-ij, . . . , and 54-mj of the j-th column and turns off the plurality of other switches 68.

Consequently, in the case of outputting the forward multiplication-accumulation value of the j-th column in the forward process, the decoder 60 applies a voltage according to the first signal value to the m resistance change memories 64 included in the m multipliers 54 associated with the j-th column to cause the currents to flow therethrough. Then, the decoder 60 adjusts the currents flowing through the plurality of resistance change memories 64 included in the plurality of multipliers 54 associated with the columns other than the j-th column to zero.

As a result, the sum of the currents flowing through the m resistance change memories 64 included in the m multipliers 54 associated with the j-th column flows through the common signal line 66. Therefore, the current detector 70 can output the total value of the currents flowing through the m resistance change memories 64 included in the m multipliers 54 associated with the j-th column as the forward multiplication-accumulation value (vⱼ) of the j-th column.

As illustrated in FIG. 15, in the backward process, the first error value (eⱼ) of the j-th column is supplied to the m voltage generators 62 included in the multipliers 54-1j, 54-2j, . . . , 54-ij, . . . , and 54-mj of the j-th column. In the backward process, the decoder 60 controls switching of the (m×n) switches 68 so as to output the backward multiplication-accumulation values for each row. For example, in the case of outputting the backward multiplication-accumulation value of the i-th row, the decoder 60 turns on the n switches 68 associated with the multipliers 54-i1, 54-i2, . . . , 54-ij, . . . , and 54-in of the i-th row and turns off the plurality of other switches 68.

Consequently, in the case of outputting the backward multiplication-accumulation value of the i-th row in the backward process, the decoder 60 applies a voltage according to the first error value to the n resistance change memories 64 included in the n multipliers 54 associated with the i-th row to cause the currents to flow therethrough. Furthermore, the decoder 60 adjusts the currents flowing through the plurality of resistance change memories 64 included in the plurality of multipliers 54 associated with the rows other than the i-th row to zero.

As a result, the sum of the currents flowing through the n resistance change memories 64 included in the n multipliers 54 associated with the i-th row flows through the common signal line 66. Therefore, the current detector 70 can output the total value of the currents flowing through the n resistance change memories 64 included in the n multipliers 54 associated with the i-th row as the backward multiplication-accumulation value (uᵢ) of the i-th row.

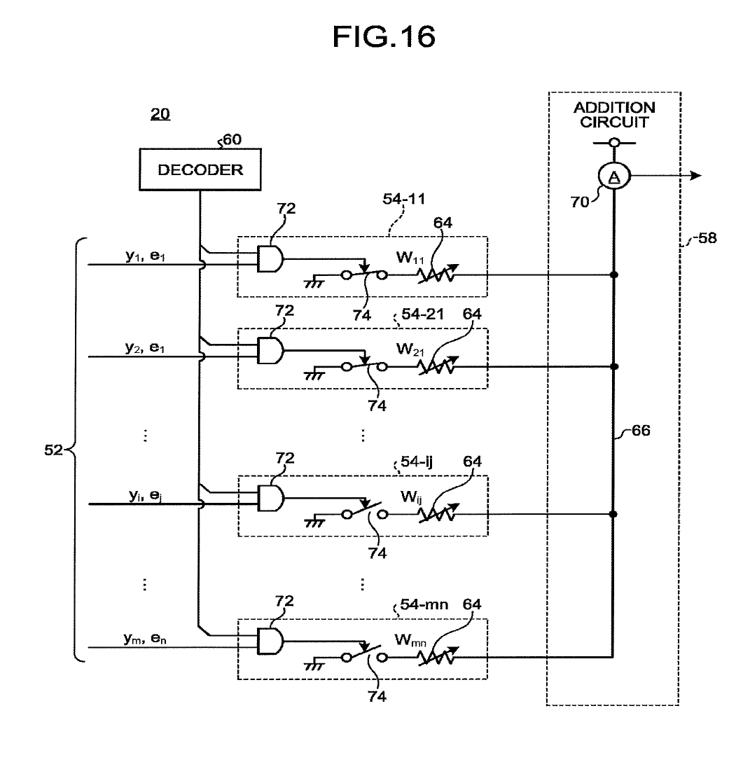

FIG. 16 is a diagram illustrating a second circuit example of the matrix computation unit 20. The matrix computation unit 20 according to the second circuit example includes members having substantially the same functions as those of the matrix computation unit 20 according to the first circuit example. The members having substantially the same functions will be denoted by the same reference numerals (or reference numerals constituted by pairs of the same reference numerals and sub-reference numerals) and the detailed explanation will be omitted except for the differences.

A neural network using a signal value expressed by binary values, an error value expressed by binary values, and a coefficient expressed by binary values is known. When computation is performed in such a neural network, the matrix computation unit 20 may have the configuration indicated by the second circuit example as illustrated in FIG. 16. Note that the present embodiment will illustrate an example using, as a signal expressed by binary values, a signal that switches H logic and L logic. However, the signal expressed by binary values may be a signal for switching 0 and 1, a signal for switching −1 and +1, a signal for switching an arbitrary first value and an arbitrary second value, or the like.

Each of the (m×n) multipliers 54 according to the second circuit example includes an AND circuit 72, a resistance change memory 64, and a voltage switch 74. In addition, the addition circuit 58 according to the second circuit example includes the common signal line 66, and the current detector 70.

The AND circuit 72 performs an AND operation between the signal value or the error value output from the acquisition circuit 52 and a select signal supplied from the decoder 60. That is, the AND circuit 72 outputs the signal value or the error value output from the acquisition circuit 52 when the select signal supplied from the decoder 60 is the H logic and, when the select signal is the L logic, always outputs the L logic regardless of the signal value or the error value.

The voltage switch 74 is turned on (connected) when the output value from the AND circuit 72 is the H logic and turned off when the output value from the AND circuit 72 is the L logic. When turned on, the voltage switch 74 connects a first potential (for example, the ground potential or the common potential) and the first end of the resistance change memory 64. When turned off, the voltage switch 74 disconnects (opens) the first potential and the first end of the resistance change memory 64.

The second end of the resistance change memory 64 is connected to the common signal line 66. The common signal line 66 is connected to a second potential (for example, a power supply potential) different from the first potential. The current detector 70 detects the current flowing through the common signal line 66.

Therefore, when the select signal is the H logic, a voltage according to the signal value or the error value output from the acquisition circuit 52 is applied to the resistance change memory 64 and a current flows therethrough. In addition, when the select signal is the L logic, a voltage is not applied (that is, a voltage of zero is applied) to the resistance change memory 64 regardless of the signal value and the error value output from the acquisition circuit 52 and a current does not flow therethrough.

In the resistance change memory 64 included in each of the (m×n) multipliers 54, the conductance is set to a value according to the coefficient of an applicable matrix associated with each multiplier 54.

In this circuit example, the coefficient is expressed by binary values. For example, when the coefficient is the H logic, the conductance of the resistance change memory 64 is set to a first value. Meanwhile, when the coefficient is the L logic, the conductance of the resistance change memory 64 is set to a second value different from the first value. The second value is, for example, a value smaller than the first value such as a value very close to zero.

In the forward process, the first signal value (yᵢ) of the i-th row is supplied to the n AND circuits 72 included in the multipliers 54-i1, 54-i2, . . . , 54-Ij, . . . , and 54-in of the i-th row. In addition, in the forward process, the decoder 60 supplies the select signal to each of the (m×n) AND circuits 72 so as to sequentially output the forward multiplication-accumulation values for each column. For example, in the case of outputting the forward multiplication-accumulation value of the j-th column, the decoder 60 supplies the H logic to the m AND circuits 72 included in the multipliers 54-1j, 54-2j, . . . , 54-ij, . . . , and 54-mj of the j-th column and supplies the L logic to the other AND circuits 72.

Consequently, in the case of outputting the forward multiplication-accumulation value of the j-th column in the forward process, the decoder 60 applies a voltage according to the first signal value to the m resistance change memories 64 included in the m multipliers 54 associated with the j-th column to cause the currents to flow therethrough. Then, the decoder 60 adjusts the currents flowing through the plurality of resistance change memories 64 included in the plurality of multipliers 54 associated with the columns other than the j-th column to zero.

As a result, the sum of the currents flowing through the m resistance change memories 64 included in the m multipliers 54 associated with the j-th column flows through the common signal line 66. Therefore, the current detector 70 can output the total value of the currents flowing through the m resistance change memories 64 included in the m multipliers 54 associated with the j-th column as the forward multiplication-accumulation value (vⱼ) of the j-th column.

In the backward process, the first error value (eⱼ) of the j-th column is supplied to the m AND circuits 72 included in the multipliers 54-1j, 54-2j, . . . , 54-ij, . . . , and 54-mj of the j-th column. In the backward process, the decoder 60 supplies the select signal to each of the (m×n) AND circuits 72 so as to sequentially output the backward multiplication-accumulation values for each row. For example, in the case of outputting the backward multiplication-accumulation value of the i-th row, the decoder 60 supplies the H logic to the n AND circuits 72 included in the multipliers 54-i1, 54-i2, . . . , 54-ij, . . . , and 54-in of the i-th row and supplies the L logic to the plurality of other AND circuits 72.

Consequently, in the case of outputting the backward multiplication-accumulation value of the i-th row in the backward process, the decoder 60 applies a voltage according to the first error value to the n resistance change memories 64 included in the n multipliers 54 associated with the i-th row to cause the currents to flow therethrough. Furthermore, the decoder 60 adjusts the currents flowing through the plurality of resistance change memories 64 included in the plurality of multipliers 54 associated with the rows other than the i-th row to zero.

As a result, the sum of the currents flowing through the n resistance change memories 64 included in the n multipliers 54 associated with the i-th row flows through the common signal line 66. Therefore, the current detector 70 can output the total value of the currents flowing through the n resistance change memories 64 included in the n multipliers 54 associated with the i-th row as the backward multiplication-accumulation value (uᵢ) of the i-th row.

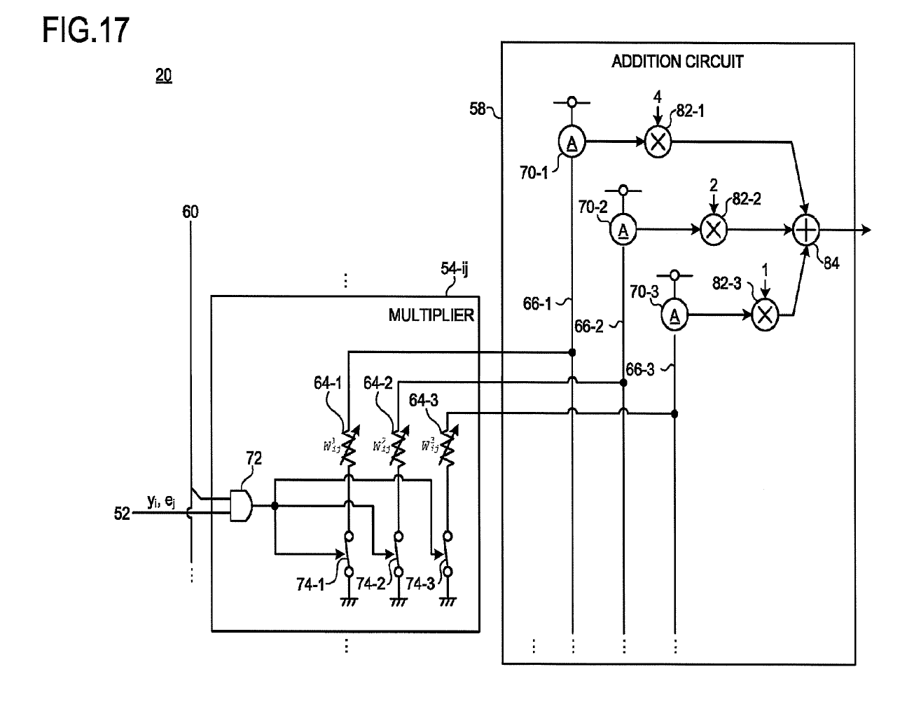

FIG. 17 is a diagram illustrating a third circuit example of the matrix computation unit 20. The matrix computation unit 20 according to the third circuit example includes members having substantially the same functions as those of the matrix computation unit 20 according to the second circuit example. The members having substantially the same functions will be denoted by the same reference numerals (or reference numerals constituted by pairs of the same reference numerals and sub-reference numerals) and the detailed explanation will be omitted except for the differences.

For example, a neural network using a signal value expressed by binary values and an error value expressed by binary values and using a coefficient expressed by multivalues (for example, four bits, eight bits, or 16 bits) is known. When the neural network device 10 performs computation in such a neural network, the matrix computation unit 20 may have the configuration indicated by the third circuit example as illustrated in FIG. 17.

Each of the (m×n) multipliers 54 according to the third circuit example includes the AND circuit 72, L resistance change memories 64 (L is an integer greater than or equal to two), and L voltage switches 74. In addition, the addition circuit 58 according to the third circuit example includes L common signal lines 66, L current detectors 70, L load multiplying units 82, and an adder 84.

Different loads are allocated to each of the L resistance change memories 64. In this circuit example, the multiplier 54 includes a first resistance change memory 64-1 to which a load of 2² (=4) is allocated, a second resistance change memory 64-2 to which a load of 2¹ (=2) is allocated, and a third resistance change memory 64-3 to which a load of 2⁰ (=1) is allocated.

The L voltage switches 74 are associated one-to-one with the L resistance change memories 64. For example, a first voltage switch 74-1 is associated with the first resistance change memory 64-1. A second voltage switch 74-2 is associated with the second resistance change memory 64-2. A third voltage switch 74-3 is associated with the third resistance change memory 64-3.

Each of the L voltage switches 74 is turned on (connected) when the output value from the AND circuit 72 is the H logic and turned off (opened) when the output value from the AND circuit 72 is the L logic. When turned on, each of the L voltage switches 74 connects the first potential (for example, the ground potential or the common potential) and the first end of the associated resistance change memory 64. In addition, when turned off, each of the L voltage switches 74 disconnects the first potential and the first end of the associated resistance change memory 64.

Therefore, when the select signal supplied from the decoder 60 is the H logic, a voltage according to the signal value or the error value output from the acquisition circuit 52 is applied to each of the L resistance change memories 64 and a current flows therethrough. Meanwhile, when the select signal supplied from the decoder 60 is the L logic, a voltage is not applied (a voltage of zero is applied) to each of the L resistance change memories 64 regardless of the signal value or the error value output from the acquisition circuit 52 and a current does not flow therethrough.

The conductances of the respective L resistance change memories 64 are set such that the sum of values obtained by multiplying the loads and the conductances individually allocated thereto becomes the coefficient associated with the corresponding multiplier 54. That is, a value obtained by calculating the multiplication values of the loads and the conductances allocated to the respective L resistance change memories 64 and adding the calculated L multiplication values serves as the coefficient corresponding to the multiplier 54 included in an applicable matrix.

For example, when the coefficient is expressed by a three-bit binary number, the conductance of the first resistance change memory 64-1 is set to a value of the first bit of the coefficient. Meanwhile, the conductance of the second resistance change memory 64-2 is set to a value of the second bit of the coefficient. In addition, the conductance of the third resistance change memory 64-3 is set to a value of the third bit of the coefficient.

The L common signal lines 66 are associated one-to-one with the L resistance change memories 64. For example, a first common signal line 66-1 is associated with the first resistance change memory 64-1. A second common signal line 66-2 is associated with the second resistance change memory 64-2. A third common signal line 66-3 is associated with the third resistance change memory 64-3.

The second end of each of the L resistance change memories 64 is connected to the corresponding common signal line 66. Each of the L common signal lines 66 is connected to the second potential (for example, the power supply potential) different from the first potential.

The L current detectors 70 are associated one-to-one with the L common signal lines 66. Each of the L current detectors 70 detects a current flowing through the associated common signal line 66. For example, a first current detector 70-1 detects a current flowing through the first common signal line 66-1. A second current detector 70-2 detects a current flowing through the second common signal line 66-2. A third current detector 70-3 detects a current flowing through the third common signal line 66-3.

The L load multiplying units 82 are associated one-to-one with the L current detectors 70. Each of the L load multiplying units 82 multiplies the current value detected by the associated current detector 70 by the load allocated to the corresponding resistance change memory 64. For example, a first load multiplying unit 82-1 multiplies the current value detected by the first current detector 70-1 by a load of 2² (=4) allocated to the first resistance change memory 64-1. A second load multiplying unit 82-2 multiplies the current value detected by the second current detector 70-2 by a load of 2¹ (=2) allocated to the second resistance change memory 64-2. A third load multiplying unit 82-3 multiplies the current value detected by the third current detector 70-3 by a load of 2⁰ (=1) allocated to the third resistance change memory 64-3.

The adder 84 adds the values output from the L load multiplying units 82 to output a resultant value as the forward multiplication-accumulation value or the backward multiplication-accumulation value.

In the third circuit example as described above, in each of the (m×n) multipliers 54, a voltage according to the first signal value corresponding to a row with which each multiplier 54 is associated is applied to the respective L resistance change memories 64 in the forward process. In addition, the addition circuit 58 adds the sums of values obtained by multiplying the currents flowing through the respective L resistance change memories 64 and the allocated loads for each column of the coefficient matrix, thereby calculating the n forward multiplication-accumulation values.

Furthermore, in the third circuit example as described above, in each of the (m×n) multipliers 54, a voltage according to the first error value corresponding to a column with which each multiplier 54 is associated is applied to the respective L resistance change memories 64 in the backward process. In addition, the addition circuit 58 adds the sums of values obtained by multiplying the currents flowing through the respective L resistance change memories 64 and the allocated loads for each row of the coefficient matrix, thereby calculating the m backward multiplication-accumulation values.

Consequently, in the forward process, the matrix computation unit 20 having such a configuration can perform matrix multiplication between the m first signal values expressed by binary values and the coefficient matrix including the (m×n) coefficients expressed by multivalues to output the n forward multiplication-accumulation values expressed by multivalues. In the backward process, the matrix computation unit 20 having such a configuration also can perform matrix multiplication between the coefficient matrix including the (m×n) coefficients expressed by multivalues and the n first error values expressed by binary values to output m backward multiplication-accumulation values expressed by multivalues.

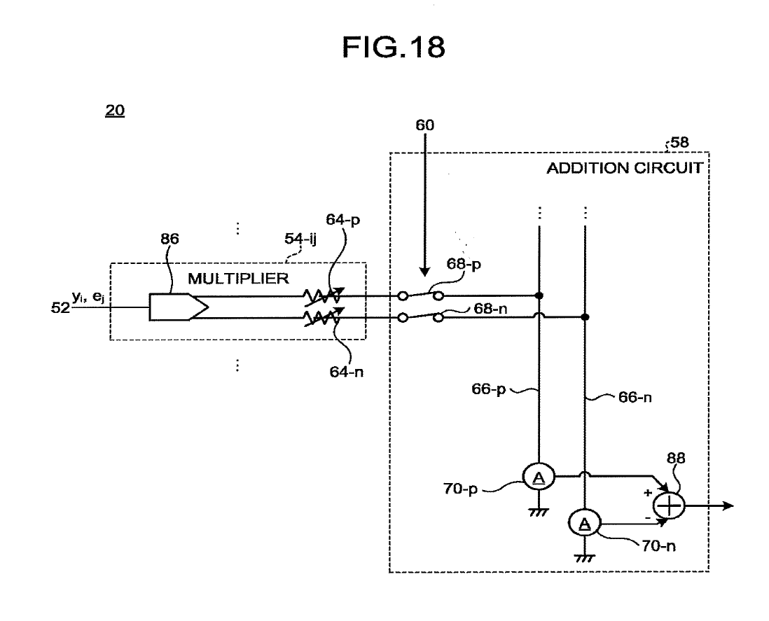

FIG. 18 is a diagram illustrating a fourth circuit example of the matrix computation unit 20. The matrix computation unit 20 according to the fourth circuit example includes members having substantially the same functions as those of the matrix computation unit 20 according to the first circuit example. The members having substantially the same functions will be denoted by the same reference numerals (or reference numerals constituted by pairs of the same reference numerals and sub-reference numerals) and the detailed explanation will be omitted except for the differences.

Each of the (m×n) multipliers 54 according to the fourth circuit example includes a differential voltage generator 86, a positive-side resistance change memory 64-p, and a negative-side resistance change memory 64-n. In addition, the addition circuit 58 according to the fourth circuit example includes a positive-side common signal line 66-p, a negative-side common signal line 66-n, (m×n) positive-side switches 68-p, (m×n) negative-side switches 68-n, a positive-side current detector 70-p, a negative-side current detector 70-n, and a subtractor 88.

The differential voltage generator 86 generates a differential voltage according to a value supplied from the acquisition circuit 52.

The first end of the positive-side resistance change memory 64-p is connected to a positive-side output end of the differential voltage generator 86. The second end of the positive-side resistance change memory 64-p is connected to the positive-side common signal line 66-p via the positive-side switch 68-p provided in correspondence with the multiplier 54 including this positive-side resistance change memory 64-p.

The first end of the negative-side resistance change memory 64-n is connected to a negative-side output end of the differential voltage generator 86. The second end of the negative-side resistance change memory 64-n is connected to the negative-side common signal line 66-n via the negative-side switch 68-n provided in correspondence with the multiplier 54 including this negative-side resistance change memory 64-n.

The positive-side common signal line 66-p is connected to a predetermined potential. The (m×n) positive-side switches 68-p are provided in one-to-one correspondence with the (m×n) multipliers 54. Each of the (m×n) positive-side switches 68-p turns on (connect) or turns off (disconnect) the connection between the positive-side resistance change memory 64-p included in the corresponding multiplier 54 and the positive-side common signal line 66-p according to the control of the decoder 60. The positive-side current detector 70-p detects a current flowing through the positive-side common signal line 66-p.

The negative-side common signal line 66-n is connected to a predetermined potential. The (m×n) negative-side switches 68-n are provided in a one-to-one correspondence with the (m×n) multipliers 54. Each of the (m×n) negative-side switches 68-n turns on (connect) or turns off (disconnect) the connection between the negative-side resistance change memory 64-n included in the corresponding multiplier 54 and the negative-side common signal line 66-n according to the control of the decoder 60. The negative-side current detector 70-n detects a current flowing through the negative-side common signal line 66-n.

The subtractor 88 performs subtraction between a value output from the positive-side current detector 70-p and a value output from the negative-side current detector 70-n to output a resultant value as the forward multiplication-accumulation value or the backward multiplication-accumulation value.

The respective conductances of the positive-side resistance change memory 64-p and the negative-side resistance change memory 64-n included in each of the (m×n) multipliers 54 are set such that a difference value between the conductances becomes the coefficient associated with the corresponding multiplier 54.

In the fourth circuit example as described above, in each of the (m×n) multipliers 54, a differential voltage according to the first signal value corresponding to a column with which each multiplier 54 is associated is applied to the positive-side resistance change memory 64-p and the negative-side resistance change memory 64-n in the forward process. Then, the addition circuit 58 adds the difference values between the currents flowing through the positive-side resistance change memories 64-p and the currents flowing through the negative-side resistance change memories 64-n for each column of the coefficient matrix, thereby calculating the n forward multiplication-accumulation values.

Furthermore, in the fourth circuit example as described above, in each of the (m×n) multipliers 54, a differential voltage according to the first error value corresponding to a row with which each multiplier 54 is associated is applied to the positive-side resistance change memory 64-p and the negative-side resistance change memory 64-n in the backward process. Then, the addition circuit 58 adds the difference values between the currents flowing through the positive-side resistance change memories 64-p and the currents flowing through the negative-side resistance change memories 64-n for each row of the coefficient matrix, thereby calculating the m backward multiplication-accumulation values.

Consequently, in the forward process, the matrix computation unit 20 having such a configuration can perform matrix multiplication between the m first signal values and the coefficient matrix using differential signals to output the n forward multiplication-accumulation values. In the backward process, the matrix computation unit 20 also can perform matrix multiplication between the coefficient matrix including the (m×n) coefficients and the n first error values using differential signals to output the m backward multiplication-accumulation values.

In addition, the matrix computation unit 20 described in the embodiment also can be applied to applications other than the neural network. For example, the matrix computation unit 20 can be caused to function as a computing device that executes matrix computation. In this case, the matrix computation unit 20 performs matrix computation between a forward first matrix of one row and m columns and a coefficient matrix of m rows and n columns (m and n are integers greater than or equal to one and, in a case where one thereof is one, the other is greater than or equal to two) and outputs a forward second matrix of one row and n columns. Furthermore, the matrix computation unit 20 performs matrix computation between the coefficient matrix and a backward first matrix of n rows and one column and outputs a backward second matrix of m rows and one column.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A neural network device comprising:
a control unit to cause a plurality of layers, each of which executes a process, to execute a forward process of propagating a plurality of signal values in a forward direction, and a backward process of propagating a plurality of error values in a backward direction; and
a matrix computation unit to perform computation on a plurality of values propagated at least some of interlayers in the plurality of layers, wherein
the plurality of layers includes a first layer and a second layer adjacent to the first layer in the forward direction, and
the matrix computation unit includes:
(m×n) multipliers provided in one-to-one correspondence with (m×n) coefficients included in a coefficient matrix of m rows and n columns (m and n are integers greater than or equal to one and, in a case where one of m and n is one, the other is greater than or equal to two); and
an addition circuit to switch a pattern for adding values output from the respective (m×n) multipliers between the forward process and the backward process.

2. The device according to claim 1, wherein
in the forward process,
the first layer outputs m first signal values associated one-to-one with m rows of the coefficient matrix,
each multiplier of the (m×n) multipliers multiplies a first signal value corresponding to a row with which the multiplier is associated among the m first signal values and a coefficient with which the multiplier is associated among the (m×n) coefficients, and
the addition circuit adds (m×n) multiplication values output from the (m×n) multipliers for each column to calculate n forward multiplication-accumulation values, and
in the backward process,
the second layer outputs n first error values associated one-to-one with n columns of the coefficient matrix,
each multiplier of the (m×n) multipliers multiplies a first error value corresponding to a column with which the multiplier is associated among the n first error values and a coefficient with which the multiplier is associated among the (m×n) coefficients, and
the addition circuit adds (m×n) multiplication values output from the (m×n) multipliers for each row to calculate m backward multiplication-accumulation values.

3. The device according to claim 2, wherein
each of the (m×n) multipliers is implemented by hardware.

4. The device according to claim 2, wherein
a multiplier associated with a coefficient of an i-th row (i is an arbitrary integer greater than or equal to one and less than or equal to m) and a j-th column (j is an arbitrary integer greater than or equal to one and less than or equal to n):
in the forward process, multiplies a first signal value associated with the i-th row of the coefficient matrix and a coefficient of the i-th row and the j-th column included in the coefficient matrix; and
in the backward process, multiplies a coefficient of the i-th row and the j-th column included in the coefficient matrix and a first error value associated with the j-th column of the coefficient matrix.

5. The device according to claim 4, wherein
the addition circuit:
in the forward process, adds m multiplication values output from m multipliers associated with the j-th column of the coefficient matrix to calculate a forward multiplication-accumulation value of the j-th column; and
in the backward process, adds n multiplication values output from n multipliers associated with the i-th row of the coefficient matrix to calculate a backward multiplication-accumulation value of the i-th row.

6. The device according to claim 2, wherein, in the forward process, the second layer supplies each of the n forward multiplication-accumulation values calculated by the matrix computation unit to an activation function to calculate n second signal values.

7. The device according to claim 2, wherein
the first layer supplies each of m previous multiplication-accumulation values to an error function to calculate m inverse transform values associated one-to-one with m rows of the coefficient matrix,
in the backward process, the first layer multiplies the m backward multiplication-accumulation values and the m inverse transform values for each row to calculate m second error values, and
the m previous multiplication-accumulation values are in values supplied to the activation function by the first layer to calculate the m first signal values in the forward process.

8. The device according to claim 7, wherein an error function for calculating an inverse transform value associated with an i-th row is a derivative of an activation function for calculating a first signal value associated with the i-th row.

9. The device according to claim 2, further comprising a coefficient storage unit to store the (m×n) coefficients included in the coefficient matrix.

10. The device according to claim 2, wherein each multiplier of the (m×n) multipliers includes a resistance change memory set to a conductance according to a coefficient with which the multiplier is associated.

11. The device according to claim 10, wherein
in the forward process,
in each multiplier of the (m×n) multipliers, a voltage according to a first signal value corresponding to a row with which the multiplier is associated is applied to the resistance change memory included in the multiplier, and
the addition circuit adds currents flowing through (m×n) resistance change memories included in the (m×n) multipliers for each column to calculate the n forward multiplication-accumulation values, and
in the backward process,
in each multiplier of the (m×n) multipliers, a voltage according to a first error value corresponding to a column with which the multiplier is associated is applied to the resistance change memory included in the multiplier, and
the addition circuit adds currents flowing through the (m×n) resistance change memories included in the (m×n) multipliers for each row to calculate the m backward multiplication-accumulation values.

12. The device according to claim 11, wherein
in each of the (m×n) resistance change memories included in the (m×n) multipliers, a voltage according to a first signal value or a first error value is applied to a first end and a second end is connected to a predetermined potential via a common signal line, and
the addition circuit outputs a value of a current flowing through the common signal line.

13. The device according to claim 12, further comprising a decoder to accept designation of the forward process or the backward process, and designation as to which of the n forward multiplication-accumulation values is to be output or which of the m backward multiplication-accumulation values is to be output, wherein
the decoder:
when outputting a forward multiplication-accumulation value of a j-th column in the forward process,
applies a voltage according to a first signal value to m resistance change memories included in m multipliers associated with the j-th column to cause a current to flow through the m resistance change memories and cause currents flowing through a plurality of resistance change memories included in a plurality of multipliers associated with columns other than the j-th column, to be zero; and
when outputting a backward multiplication-accumulation value of an i-th row in the backward process,
applies a voltage according to a first error value to n resistance change memories included in n multipliers associated with the i-th row to cause a current to flow through the n resistance change memories and cause currents flowing through a plurality of resistance change memories included in a plurality of multipliers corresponding to rows other than the i-th row, to be zero.

14. The device according to claim 13, wherein
each of the m first signal values and the n first error values is a binary value, and
when applying voltages according to the first signal values or the first error values, each multiplier of the (m×n) multipliers applies a predetermined voltage to a resistance change memory included in the multiplier when a supplied first signal value or a supplied first error value is a first value, and cause a current flowing through a resistance change memory included in the multiplier, to be zero when a supplied first signal value or a supplied first error value is a second value.

15. The device according to claim 2, wherein
each of the (m×n) multipliers includes L (L is an integer greater than or equal to two) resistance change memories to which different loads are individually allocated,
in the L resistance change memories, respective conductances are set such that a sum of values obtained by multiplying the allocated loads and the conductances becomes a coefficient associated with the multiplier,
in the forward process,
in each multiplier of the (m×n) multipliers, a voltage according to a first signal value corresponding to a row with which the multiplier is associated is applied to each of the L resistance change memories, and
the addition circuit adds sums of values obtained by multiplying currents flowing through respective L resistance change memories and the allocated loads for each column of the coefficient matrix to calculate the n forward multiplication-accumulation values, and
in the backward process,
in each multiplier of the (m×n) multipliers, a voltage according to a first error value corresponding to a column with which the multiplier is associated is applied to each of the L resistance change memories, and
the addition circuit adds sums of values obtained by multiplying currents flowing through respective L resistance change memories and the allocated loads for each row of the coefficient matrix to calculate the m backward multiplication-accumulation values.

16. The device according to claim 10, wherein
each of the (m×n) multipliers includes a positive-side resistance change memory and a negative-side resistance change memory,
in the positive-side resistance change memory and the negative-side resistance change memory, respective conductances are set such that a difference value of the conductances becomes a coefficient associated with the multiplier,
in the forward process,
in each multiplier of the (m×n) multipliers, a differential voltage according to a first signal value corresponding to a column with which the multiplier is associated is applied to the positive-side resistance change memory and the negative-side resistance change memory, and
the addition circuit adds difference values between currents flowing through positive-side resistance change memories and currents flowing through negative-side resistance change memories for each column of the coefficient matrix to calculate the n forward multiplication-accumulation values, and
in the backward process,
in each multiplier of the (m×n) multipliers, a differential voltage according to a first error value corresponding to a row with which the multiplier is associated is applied to the positive-side resistance change memory and the negative-side resistance change memory, and
the addition circuit adds difference values between currents flowing through positive-side resistance change memories and currents flowing through negative-side resistance change memories for each row of the coefficient matrix to calculate the m backward multiplication-accumulation values.

17. A computing device that executes a forward process of performing matrix computation between a forward first matrix of one row and m columns and a coefficient matrix of m rows and n columns (m and n are integers greater than or equal to one and, in a case where one of m and n is one, the other is greater than or equal to two) to output a forward second matrix of one row and n columns, and a backward process of performing matrix computation between the coefficient matrix and a backward first matrix of n rows and one column to output a backward second matrix of m rows and one column, the computing device comprising:
(m×n) multipliers provided in one-to-one correspondence with (m×n) coefficients included in the coefficient matrix, and
an addition circuit to switch a pattern for adding values output from the respective (m×n) multipliers between the forward process and the backward process.
